(19) United States
(12) Patent Application Publication
(10) Pub. No.: US 2023/0294115 A1
(43) Pub. Date: Sep. 21, 2023

(54) Dual-Outlet Water Adapter for Gardening

(71) Applicant: SHIN TAI SPURT WATER OF THE GARDEN TOOLS CO., LTD, Lukang Township (TW)

(72) Inventor: Chin-Yuan Chen, Lukang Township (TW)

(21) Appl. No.: 17/697,873

(22) Filed: Mar. 17, 2022

(51) Int. Cl. B05B 1/16

(52) U.S. Cl. CPC B05B 1/1636

(57) ABSTRACT

A dual-outlet water adapter for gardening has a main body and at least two the switch valve set. The main body is provided with an input portion, at least two controlling portions and a first chamber. The controlling portion has a second chamber located inside the main body and an output chamber in the main body, and a through aperture is arranged on one side of the peripheral edge of the second chamber. Each switch valve set includes a control valve. The control valve has a knob, a valve tube protrudes from the knob, a through hole runs through the periphery of the valve tube, and a sealing member is embedded.

### BACKGROUND OF INVENTION

### Field of Invention

The present invention relates to a dual-outlet water adapter for gardening, and more particularly to a dual-outlet water adapter for gardening capable of being connecting to multiple garden watering tools.

### Description of the Related Art

In gardening work, frequent watering is a necessary process to avoid the death of plants due to lack of water, and usually the planting range of plants is wide, or far from the water source, so the process of watering is to execute with water pipes. However, the intensity of water directly flowing from the water pipe is strong with small range, so the watering process is slow and is easy to damage or water the plants. Therefore, it is necessary to install gardening watering tools that can spray water on a large area to achieve more efficient and comprehensive irrigation.

However, the above conventional structure still has the following problems in practical application: One water pipe can only provide one connection for one gardening water spray tool, but cannot be divided to multiple gardening water spray tools, it is necessary to pull out multiple water pipes from the water source, which is quite inconvenient to use and it is easy to cause confusion in the configuration of the pipeline. Also, the water pipe does not have the function of water control, so in order to turn on and off the water or change the flow rate of the water, it can only be done back and forth between the water source and the water source, which is quite troublesome, time-consuming and labor-intensive.

Therefore, it is desirable to provide an adjustable garden sprinkler to mitigate and/or obviate the aforementioned problems.

### SUMMARY OF THE INVENTION

An objective of present invention is to provide a dual-outlet water adapter for gardening.

To achieve these and other objects of the present invention, a dual-outlet water adapter for gardening has a main body and at least two switch valve sets. The main body has an input portion, at least two controlling portions and a first chamber, the input portion configured for connection to a water source and sending water into the first chamber; each controlling portion has a second chamber in the main body and an output chamber in the main body, and a through aperture is disposed at an edge of the second chamber; a connection between the through aperture and the first chamber configured to transfer water from the first chamber to the second chamber and then output from the output chamber; the output chamber has a joint for assembly with a watering tool; each controlling portion also has a spiral channel with a positioning pin pushed by a spring. The switch valve set has a control valve with a knob, the knob has a valve tube inserted in the second chamber of the controlling portion and protrudes from the main body; the knob further has a positioning protrusion and a plurality of engaging grooves on a side of the valve tube, the spiral channel accepting the positioning protrusion to limit rotation of the control valve on the controlling portion, and the positioning pin is configured for insertion into each engaging groove individually; and the valve tube has a through hole and a sealing member is embedded into the valve tube adjacent to the through hole.

Other objects, advantages, and novel features of invention will become more apparent from the following detailed description when taken in conjunction with the accompanying drawings.

### BRIEF DESCRIPTION OF DRAWINGS

FIG. 1 is a three-dimensional combined view of a preferred embodiment according to the present invention.

FIG. 2 is a three-dimensional exploded view according to the preferred embodiment of the present invention.

FIG. 3 is a detailed exploded view according to the preferred embodiment of the present invention.

FIG. 4 is the combined plan according to the preferred embodiment of the present invention.

FIG. 5 is a cross-sectional view of the composition according to the preferred embodiment of the present invention.

FIG. 6 is a state drawing of the water source being fed into the main body according to the preferred embodiment of the present invention.

FIG. 7 is state drawing of the water outlet according to the preferred embodiment of the present invention.

FIG. 8 is another view of the water outlet according to the preferred embodiment of the present invention.

FIG. 9 shows when the water flow being changed and the water is completely turned off according to the preferred embodiment of the present invention.

FIG. 10 shows when the flow rate of the outlet being changed and the water being completely turned off according to the preferred embodiment of the present invention.

FIG. 11 is a cross-sectional view showing when the water is closed according to the preferred embodiment of the present invention.

FIG. 12 shows another preferred embodiment of the present invention.

### DETAILED DESCRIPTION OF THE PREFERRED EMBODIMENT

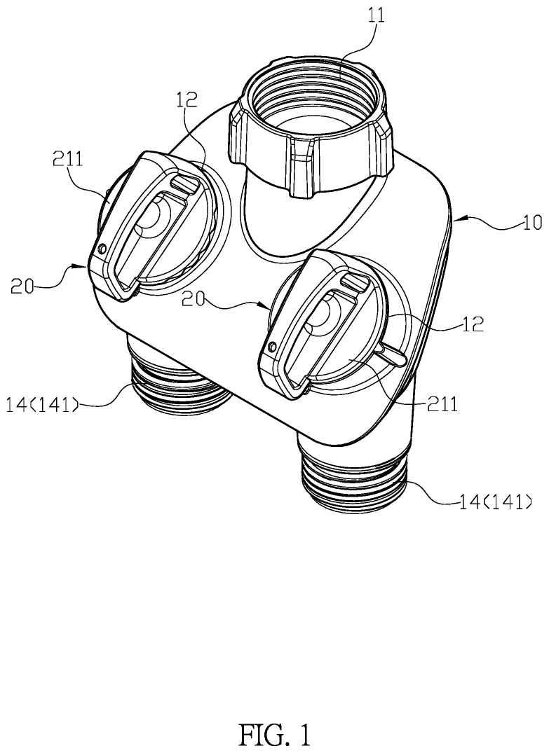

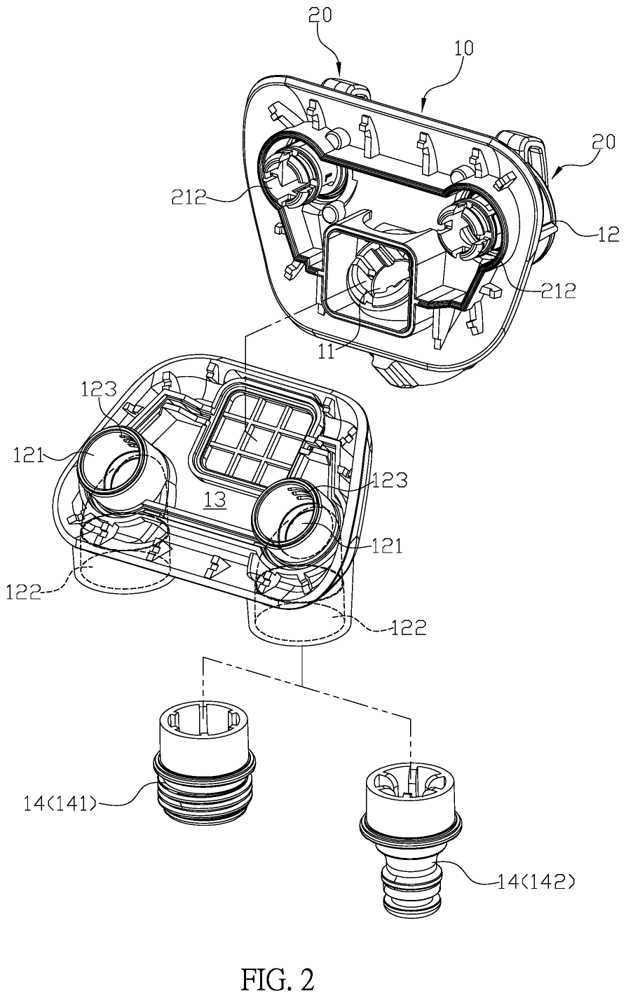

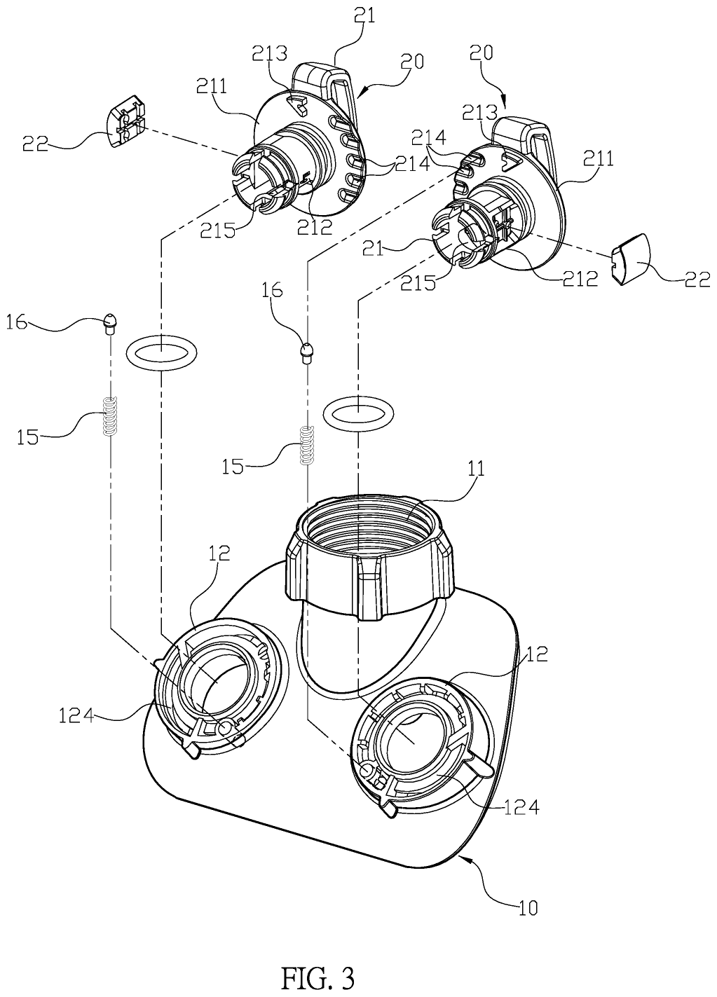

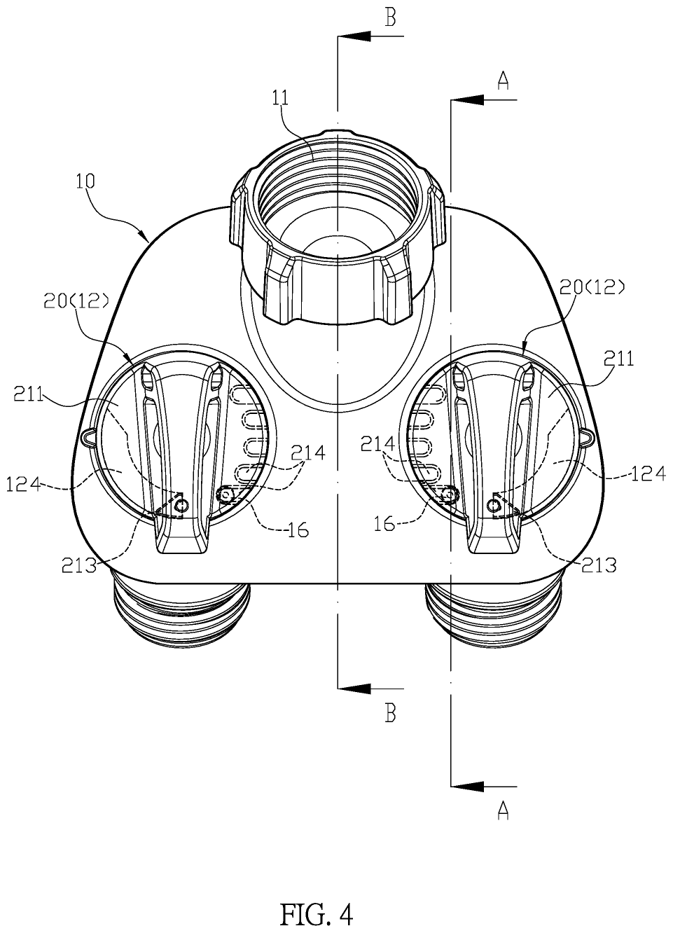

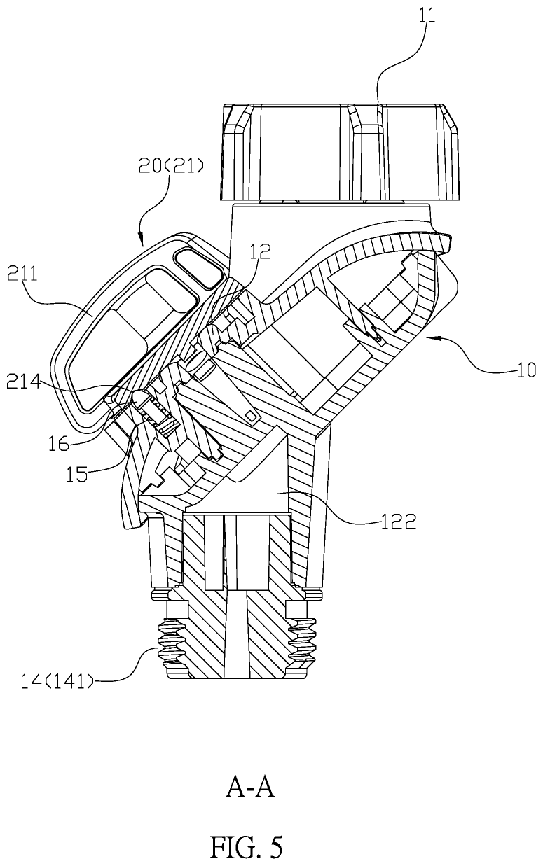

First, please refer to FIGS. 1-5. A dual-outlet water adapter for gardening comprises: a main body 10 and at lease two switch valve sets 20. The main body 10 has an input portion 11, at least two controlling portions 12 and a first chamber 13. The input portion 11 is configured for connection to a water source and sending water into the first chamber 13. Each controlling portion 12 has a second chamber 121 in the main body 10 and an output chamber 122 in the main body 10., and a through aperture 123 is disposed at an edge of the second chamber 121. A connection between the through aperture 123 and the first chamber 13 is configured to transfer water from the first chamber 13 to the second chamber 121 and then output from the output chamber 122. The output chamber 122 has a joint 14 for assembly with a watering tool. Furthermore, each controlling portion 12 also has a spiral channel 124 with a positioning pin 16 pushed by a spring 15. The switch valve set 20 has a control valve 21, and the control valve 21 has a knob 211. The knob 211 has a valve tube 212 inserted in the second chamber 121 of the controlling portion 12 and protrudes from the main body 10. The knob 211 further has a positioning protrusion 213 and a plurality of engaging grooves 214 on a side of the valve tube 212. The spiral channel 124 accepts the positioning protrusion 213 to limit rotation of the control valve 21 on the controlling portion 12, and the positioning pin 16 is configured for insertion into each engaging groove 214 individually. The valve tube 212 has a through hole 215 and a sealing member 22 is embedded into the valve tube 212 adjacent to the through hole 215. With the rotation of the control valve 21, the through hole 215 and the through aperture 123 are aligned or the sealing member 22 covers partial of the through aperture 123.

Moreover, the main body 10 is composed of two opposing housings

Also, the main body is composed of two opposing housings.

Furthermore, both of the first chamber 13 and the second chamber 121 are sleeved with a sealing ring.

In addition, the joint 14 is bonded in the output chamber 122 by a high frequency process.

Also, the joint 14 is a threaded joint 141.

Alternatively, the joint 14 is a quick-disconnect joint 142.

Furthermore, the main body 10 is assembled with two switch valve sets 20, as shown in FIGS. 1-11.

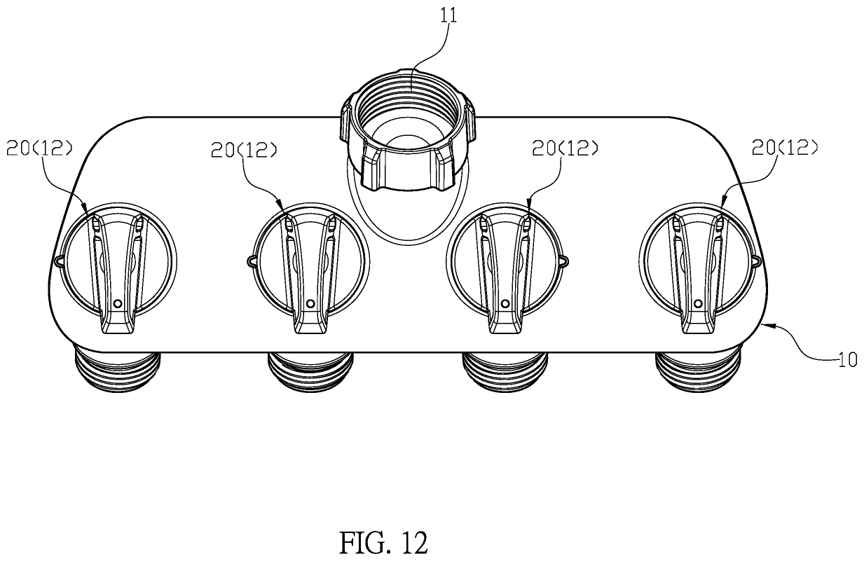

Additionally, the main body 10 is assembled with more than two switch valve sets 20, as shown in FIG. 12.

Also, the valve tube 212 has claws at one end for engaging with the second chamber 121.

Moreover, the valve tube 212 is sleeved with at least one sealing ring.

In addition, the control valve 21 is capable of being rotated 90°.

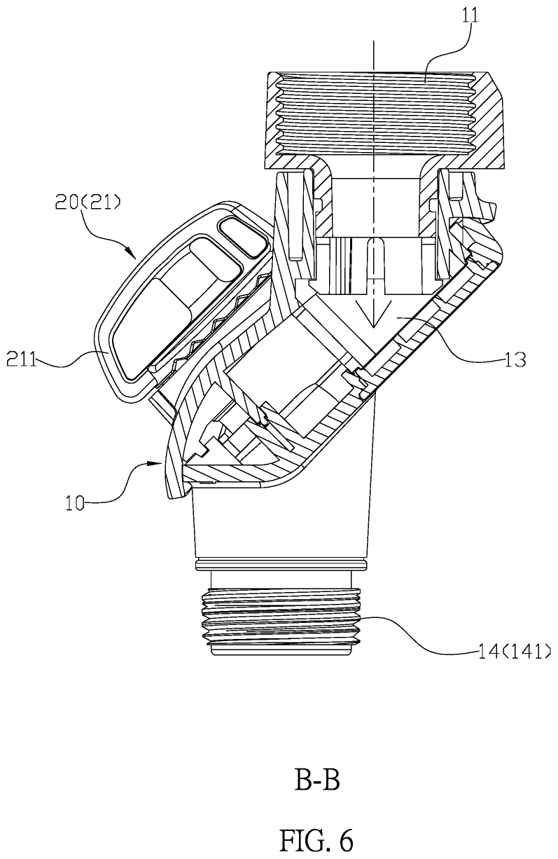

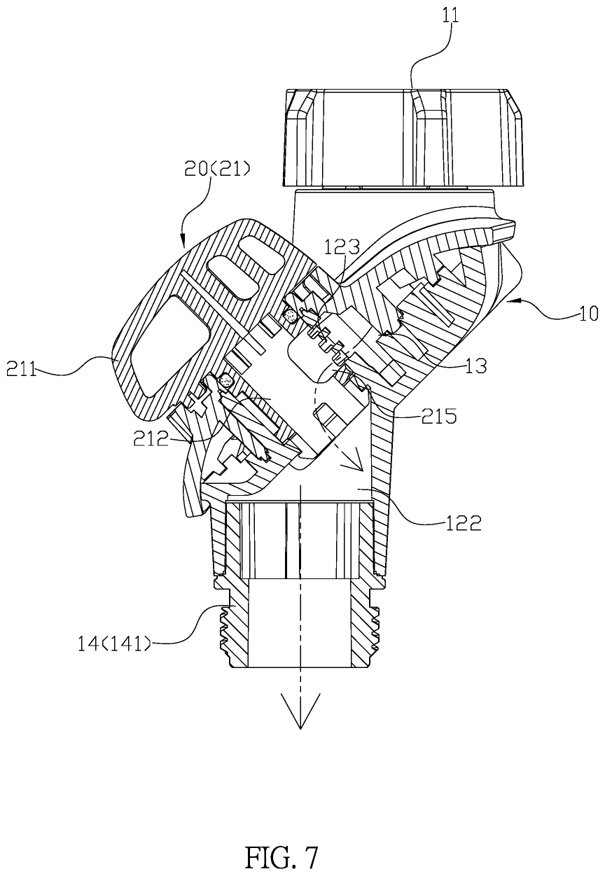

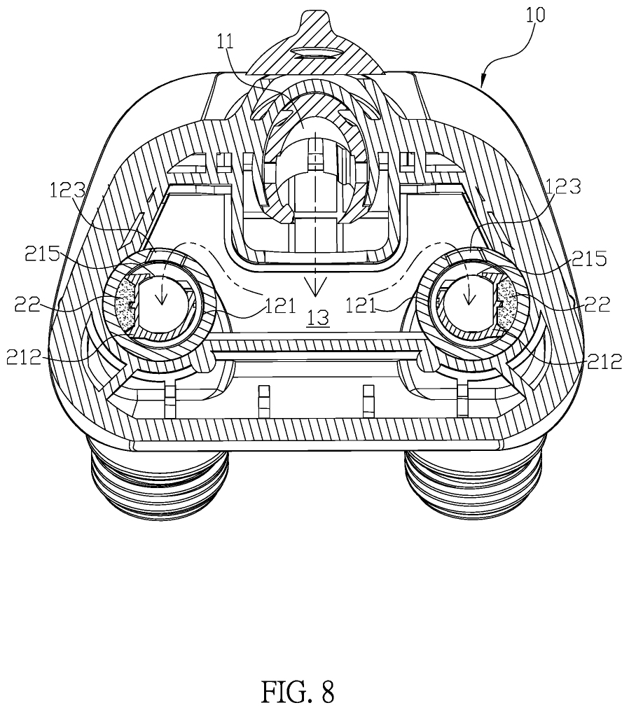

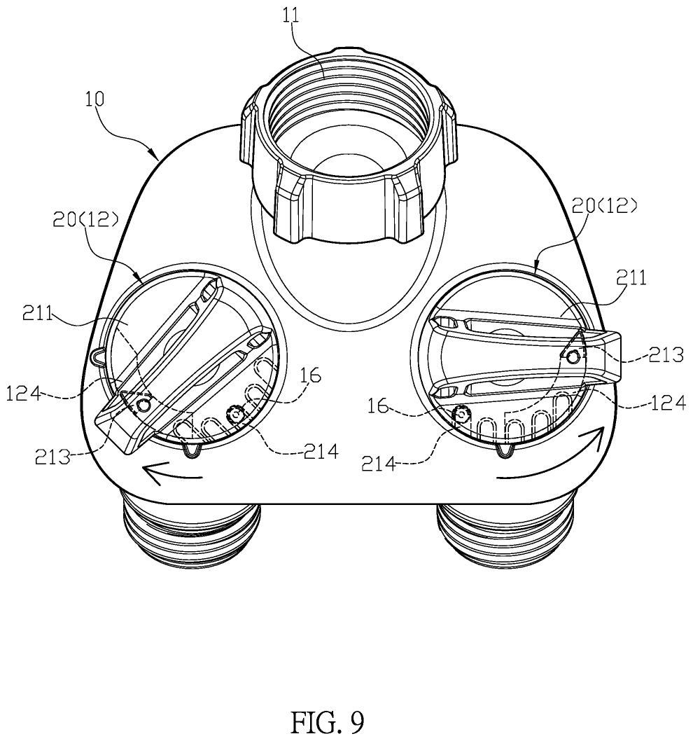

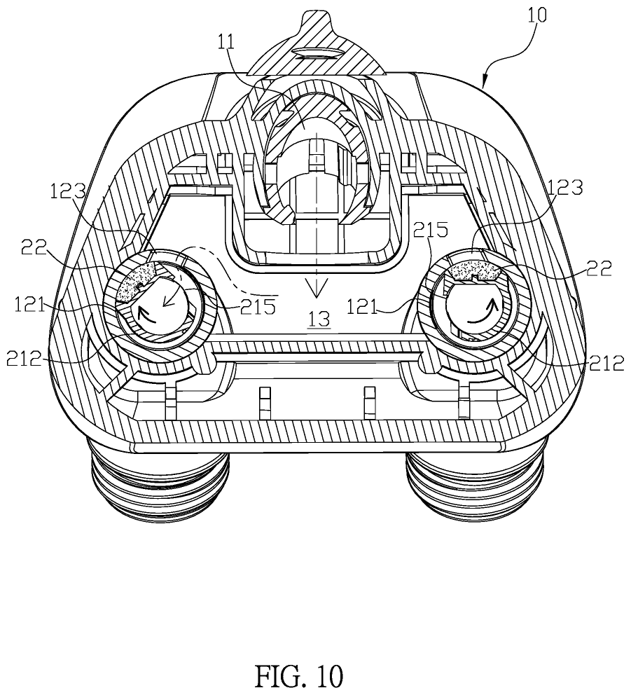

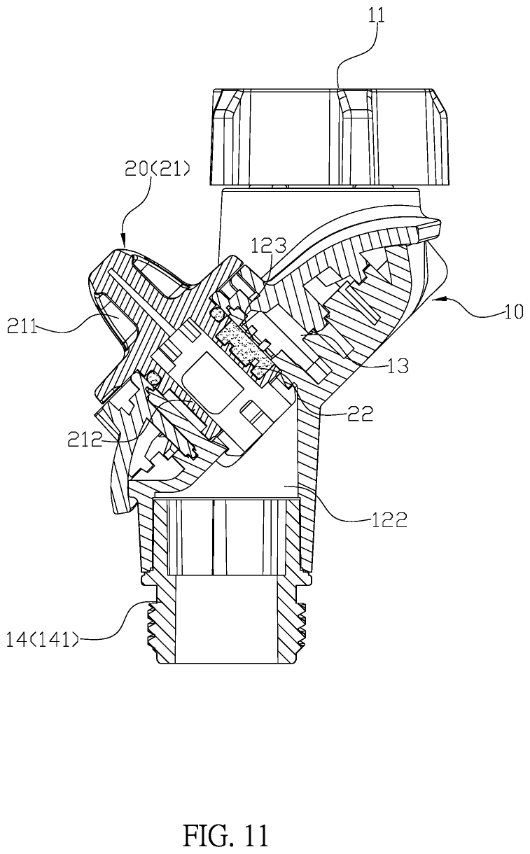

In actual use, the control valve 21 is rotated in one direction to make the through hole 215 to align with the through aperture 123, so that the water sent from the input portion 11 into the first chamber 13, as shown in FIG. 6, passes through the through aperture 123 and the through hole 215, and then flows out from the valve tube 212, the output chamber 122 and the joint 14, as shown in FIG. 7 and FIG. 8. By continuously rotating the control valve 21, as shown in FIG. 9, the sealing member 22 covers different ratio of the through aperture 123, which can be used to control the flow of water, as shown in FIG. 10, or even shut off the entire water flow, as shown in FIG. 10 and FIG. 11, so that users can turn on and off the water directly with the dual-outlet water adapter, without having to run all the way to the water source. Each switch valve set on the main body 10 is designed independently, and can also be used as a water controller for different garden water spray tools.

With the structure of the above-mentioned specific embodiment, the following benefits can be obtained: The dual-outlet water adapter structure is capable of being connected in a one-to-many manner, so when a plurality of gardening water spraying tools need to be used in the same field, it is only necessary to have one water pipe pulled out from the water source and connected to the input portion 11 of the main body 10. Therefore, the dual-outlet water adapter can be used to supply water to a plurality of gardening water spraying tools at the same time, which can be more simplified in use and can also avoid causing pipe damage. Also, each switch valve set 20 of the main body 10 are independent of each other, and can independently control the water for the garden sprinkler that is connected to it, so that the user does not have to run all the way to the water source but turn on and off the water supply directly on the dual-outlet water adapter or change the water flow, which is relatively convenient to use and saves time and effort.

Although the present invention has been explained in relation to its preferred embodiment, it is to be understood that many other possible modifications and variations can be made without departing from the spirit and scope of invention as hereinafter claimed.

What is claimed is:

1. A dual-outlet water adapter for gardening comprising: a main body and at least two switch valve sets, wherein:
the main body has an input portion, at least two controlling portions and a first chamber, the input portion configured for connection to a water source and sending water into the first chamber; each controlling portion has a second chamber in the main body and an output chamber in the main body, and a through aperture is disposed at an edge of the second chamber; a connection between the through aperture and the first chamber configured to transfer water from the first chamber to the second chamber and then output from the output chamber; the output chamber has a joint for assembly with a watering tool; each controlling portion also has a spiral channel with a positioning pin pushed by a spring;
the switch valve set has a control valve with a knob, the knob has a valve tube inserted in the second chamber of the controlling portion and protrudes from the main body; the knob further has a positioning protrusion and a plurality of engaging grooves on a side of the valve tube, the spiral channel accepting the positioning protrusion to limit rotation of the control valve on the controlling portion, and the positioning pin is configured for insertion into each engaging groove individually; and the valve tube has a through hole and a sealing member is embedded into the valve tube adjacent to the through hole.

2. The dual-outlet water adapter for gardening as claimed in claim 1, wherein the main body is composed of two opposing housings.

3. The dual-outlet water adapter for gardening as claimed in claim 2, wherein the two housings are bonded by a high frequency process.

4. The dual-outlet water adapter for gardening as claimed in claim 1, wherein both of the first chamber and the second chamber are sleeved with a sealing ring.

5. The dual-outlet water adapter for gardening as claimed in claim 1, wherein the joint is bonded in the output chamber by a high frequency process.

6. The dual-outlet water adapter for gardening as claimed in claim 1, wherein the joint is a threaded joint.

7. The dual-outlet water adapter for gardening as claimed in claim 1, wherein the joint is a quick-disconnect joint.

8. The dual-outlet water adapter for gardening as claimed in claim 1, wherein the main body is assembled with two switch valve sets.

9. The dual-outlet water adapter for gardening as claimed in claim 1, wherein the main body is assembled with more than two switch valve sets.

10. The dual-outlet water adapter for gardening as claimed in claim 1, wherein the valve tube has claws at one end for engaging with the second chamber.

11. The dual-outlet water adapter for gardening as claimed in claim 1, wherein the valve tube is sleeved with at least one sealing ring.
